(19) United States
(12) Patent Application Publication
(10) Pub. No.: US 2014/0112328 A1
(43) Pub. Date: Apr. 24, 2014

(54) Method for Automatically Accessing Wi-Fi Network and Terminal

(71) Applicant: Huawei Device Co., LTD, Shenzhen (CN)

(72) Inventor: Ji Wang, Shenzhen (CN)

(21) Appl. No.: 14/143,742

(22) Filed: Dec. 30, 2013

Related U.S. Application Data
(63) Continuation of application No. PCT/CN2012/083634, filed on Oct. 27, 2012.

(30) Foreign Application Priority Data
Oct. 29, 2011 (CN) 201110335527.6

(51) Int. Cl. H04W 48/16

(52) U.S. Cl. CPC H04W 48/16
USPC 370/338

(57) ABSTRACT

The present disclosure provides a method for automatically accessing a Wi-Fi network. The method for accessing a Wi-Fi network includes: obtaining, by a terminal, a current mobile network location identifier of the terminal; determining, by the terminal, whether the current mobile network location identifier of the terminal is stored in a Wi-Fi access location list, where the Wi-Fi access location list is used to store a related identifier corresponding to a region that provides Wi-Fi wireless signal access; and when the terminal determines that the current mobile network location identifier of the terminal is stored in the Wi-Fi access location list, putting a Wi-Fi access module in an enabled state, and starting a Wi-Fi network searching and connection process.

This application is a continuation of International Application No. PCT/CN2012/083634, filed on Oct. 27, 2012, which claims priority to Chinese Patent Application No. 201110335527.6, filed on Oct. 29, 2011, both of which are hereby incorporated by reference in their entireties.

### TECHNICAL FIELD

The present disclosure relates to wireless access technologies, and in particular embodiments, to a method for automatically accessing a Wi-Fi network and a terminal.

### BACKGROUND

A Wi-Fi (Wireless Fidelity) access technology is a technology for wirelessly connecting terminals, such as a personal computer (PC) and handheld devices (such as a PDA or Personal Digital Assistant) and a mobile phone, to a network. In an architecture in which a network is assessed through Wi-Fi, as shown in FIG. 1, a fixed terminal can access the Internet through a router and a switch, but mobile terminals, such as a mobile phone, a PDA, a Tablet (tablet computer), and a portable computer, wirelessly access the Internet through an AP (Access Point).

It can be seen from the architecture in which the network is assessed through the Wi-Fi that a Wi-Fi wireless access system provides a wireless access service through access points, but disposition of the access points is not continuous, so that coverage of Wi-Fi signal access is geographically discontinuous. A mobile terminal has mobility. In some places, there is an access point, and therefore the mobile terminal can perform Wi-Fi wireless access, but in some places, there is no access point, and therefore access cannot be provided.

For setting of a Wi-Fi function of a mobile terminal, the Wi-Fi function may be set to an enabled state, and in this state, the mobile terminal regularly searches for an access point, and in this way, even in a region where no access point exists, the mobile terminal also performs searching continuously, which increases power consumption of the terminal; and the Wi-Fi function may also be set to a disabled state, and in this way, even if the mobile terminal enters a region where an access point exists, a user needs to re-set the Wi-Fi function to be enabled, and otherwise, only a 2G/3G mobile network access manner can be adopted. However, compared with the Wi-Fi wireless access manner, the 2G/3G mobile network access manner has features of higher cost and lower rate, which not only increases a communication cost of the user but also cannot reduce pressure on service traffic of the 2G/3G mobile network of an operator.

### SUMMARY OF THE INVENTION

Based on the foregoing existing problem, embodiments of the present disclosure provide a method for automatically accessing a Wi-Fi network and a terminal, so that a terminal can automatically switch to a Wi-Fi access network.

In one aspect, the present invention provides a method for automatically accessing a Wi-Fi network, and the method includes: obtaining, by a terminal, a current mobile network location identifier of the terminal; determining, by the terminal, whether the current mobile network location identifier of the terminal is stored in a Wi-Fi access location list, where the Wi-Fi access location list is used to store a related identifier corresponding to a region that provides Wi-Fi wireless signal access; and when the terminal determines that the current mobile network location identifier of the terminal is stored in the Wi-Fi access location list, making a Wi-Fi access module be in an enabled state, and starting a Wi-Fi network searching and connection process.

In another aspect, a Wi-Fi access location list creation method is provided, and the method includes: triggering enabling of a Wi-Fi access module, and starting a network searching process; establishing, by a terminal according to a network searching result, a connection with an access point that is found through searching; and obtaining, by the terminal, a current mobile network location identifier of the terminal, and storing the mobile network location identifier in a Wi-Fi access location list.

In another aspect, a terminal is provided, and the terminal includes: a location identifier obtaining module, configured to obtain a current mobile network location identifier of the terminal; a determining module, configured to determine whether the current mobile network location identifier of the terminal is stored in a Wi-Fi access location list, where the Wi-Fi access location list is used to store a related identifier corresponding to a region that provides Wi-Fi wireless signal access; and an executing module, configured to, when the determining module determines that the current mobile network location identifier of the terminal is stored in the Wi-Fi access location list, make a Wi-Fi access module be in an enabled state, and start a Wi-Fi network searching and connection process.

In another aspect, a Wi-Fi access location list creation module is provided, and the module includes: a location identifier obtaining unit, configured to trigger enabling of a Wi-Fi access module, start a network searching process, and after establishing a connection with an access point that is found through searching, obtain a current mobile network location identifier of a terminal; and a storage processing unit, configured to store the mobile network location identifier in a Wi-Fi access location list.

It can be seen from the foregoing technical solutions that, with the method for automatically accessing a Wi-Fi network and the terminal provided in the embodiments of the present disclosure, wide region coverage of a mobile network can be used to automatically perform Wi-Fi signal access according to information stored in a Wi-Fi access location list, thereby better solving a problem of inconvenient terminal Wi-Fi working state control caused by discontinuous coverage of a Wi-Fi access point.

### BRIEF DESCRIPTION OF THE DRAWINGS

To describe the technical solutions in the embodiments of the present invention or in the prior art more clearly, the accompanying drawings required for describing the embodiments or the prior art are introduced briefly in the following. Apparently, the accompanying drawings in the following description show only some embodiments of the present invention, and persons of ordinary skill in the art may also derive other drawings from these accompanying drawings without creative efforts.

FIG. 1 is a schematic architectural diagram of a Wi-Fi access system in the prior art;

FIG. 2 is a schematic flow chart of a method for automatically accessing a Wi-Fi network according to an embodiment of the present invention;

FIG. 3 is a schematic flow chart of a Wi-Fi access location list creation method according to an embodiment of the present invention;

FIG. 4 is a schematic structural diagram of a terminal according to an embodiment of the present invention; and

FIG. 5 is a schematic structural diagram of a Wi-Fi access location list creation module according to an embodiment of the present invention.

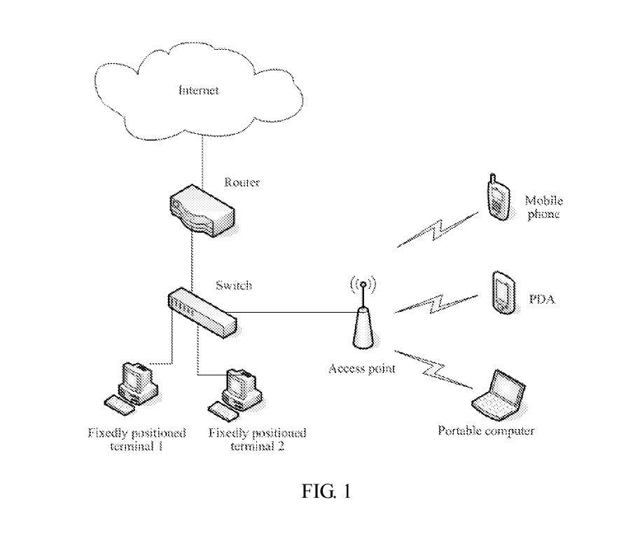

In order to make the objectives, technical solutions, and advantages of the present invention more comprehensible, the technical solutions in the embodiments of the present invention are clearly and described in the following with reference to the accompanying drawings in the embodiments of the present invention. Apparently, the embodiments to be described are only a part rather than all of the embodiments of the present invention. All other embodiments obtained by persons of ordinary skill in the art based on the embodiments of the present invention without creative efforts shall fall within the protection scope of the present invention.

### DETAILED DESCRIPTION OF ILLUSTRATIVE EMBODIMENTS

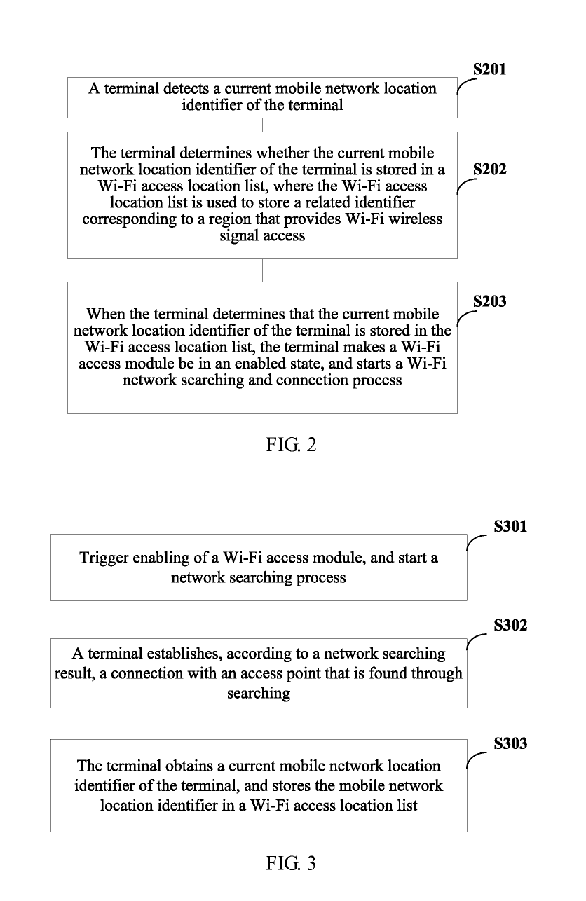

FIG. 2 is a flow diagram of one embodiment of a method of automatically accessing a Wi-Fi network. At a step S201, a terminal obtains a current mobile network location identifier of the terminal. In certain embodiments, for the mobile network location identifier, a cell identifier of a mobile network may be obtained in the following manner. The terminal may obtain, according to a cell broadcast message delivered by a mobile network, a cell identifier of the mobile network where the terminal is located.

At a step S202, the terminal determines whether the current mobile network location identifier of the terminal is stored in a Wi-Fi access location list, where the Wi-Fi access location list is used to store a related identifier corresponding to a region that provides Wi-Fi wireless signal access. The related identifier corresponding to the region that provides Wi-Fi wireless signal access is a logical identifier. In a mobile network, for example, for GSM (Global System For Mobile Communication) and WCDMA (Wideband Code Division Multiple Access) networks, the related identifier is a Cell ID; and for a CDMA (Code Division Multiple Access) network, the related identifier is an SID (System Identifier) and an NID (Network Identifier). It is understandable that, with development of network technologies, other identifiers may also be used for indication, which is not limited in the embodiment of the present invention.

Optionally, after the terminal obtains the current mobile network location identifier of the terminal, the terminal first determines, through comparison, whether the current mobile network location identifier and a previously stored mobile network location identifier are the same, and when a comparison result is that the two are not the same, the terminal determines whether the current mobile network location identifier is stored in the Wi-Fi access location list.

By adopting the foregoing manner, the terminal compares the current mobile network location identifier and the previously stored mobile network location identifier, and only when the two are not the same, the terminal determines whether the mobile network location identifier is stored in the Wi-Fi access location list, which prevents the terminal from continuously determining whether the mobile network location identifier is stored in the Wi-Fi access location list, thereby avoiding waste of a resource.

In a step S203, when the terminal determines that the current mobile network location identifier of the terminal is stored in the Wi-Fi access location list, the terminal makes a Wi-Fi access module be in an enabled state, and starts a Wi-Fi network searching and connection process. By adopting the foregoing embodiment, the terminal automatically enables the Wi-Fi access module only when detecting that the current mobile network location identifier of the terminal is in the Wi-Fi access location list. In this way, wide region coverage of the mobile network can be used to automatically perform Wi-Fi signal access according to information stored in the Wi-Fi access location list, thereby better solving a problem of inconvenient terminal Wi-Fi working state control caused by discontinuous coverage of a Wi-Fi access point.

In the foregoing method embodiment, the mobile network location identifier may specifically be a cell identifier of a mobile network, and the terminal obtains, according to a cell broadcast message delivered by a mobile network, a cell identifier of the mobile network where the terminal is located.

Optionally, the Wi-Fi access location list may further store, in advance, a Wi-Fi SSID (service set identifier) corresponding to an access point in a region that is indicated by the mobile network location identifier; and when the terminal starts a Wi-Fi network searching and connection process, the terminal may start the Wi-Fi network searching and connection process through the Wi-Fi SSID corresponding to the access point in the region where the terminal is located.

The Wi-Fi access location list stores the Wi-Fi service set identifier corresponding to the access point in the region that is indicated by the mobile network location identifier, so that when the terminal performs Wi-Fi network searching and connection, the terminal can perform a network searching and access point connection process more quickly according to these Wi-Fi SSIDs.

In a specific implementation process, in Wi-Fi settings of terminal software, in addition to original Enable and Disable, an “Automatic” option may be added. When the terminal is powered on, or when it is determined, according to the cell broadcast message delivered by the mobile network, that the mobile network location identifier of the terminal (for GSM and WCDMA networks, the cell identifier is a Cell ID; and for a CDMA network, the cell identifier is an SID and an NID) changes, the Wi-Fi access location list is searched according to the current mobile network location identifier of the terminal. If the current mobile network location identifier is stored in the list, the terminal automatically enables a Wi-Fi function, and performs normal procedures such as Wi-Fi network searching and network connection; and otherwise, the Wi-Fi access module is disabled. The foregoing process is automatically completed by the terminal, and user intervention is not required.

If the Wi-Fi access location list records information of Wi-Fi SSIDs corresponding to the mobile network location identifier, the terminal preferentially searches for these Wi-Fi SSIDs during network searching, and performs a connection process.

When the terminal enters a geographical region where a Wi-Fi signal possibly exists, in many cases, a user does not perform a data service, in consideration of power saving of the terminal, the terminal may start a process of automatically accessing a Wi-Fi network to perform procedures of Wi-Fi searching and connection only after a screen of the terminal is turned on or the user initiates a data service request.

FIG. 3 is a flow diagram of one embodiment of a method of creating a Wi-Fi access location list. At a step S301, an enabling of a Wi-Fi access module is triggered, and a network searching process is started. The triggering may be performed manually, and may also be automatically performed by a terminal.

At a step S302, the terminal establishes, according to a network searching result, a connection with an access point that is found through searching. Wi-Fi access point information is obtained according to the network searching result. A user or the terminal may automatically establish, according to the information, a connection with the access point that is found through searching.

At a step S303, the terminal obtains a current mobile network location identifier of the terminal, and stores the mobile network location identifier in a Wi-Fi access location list.

Optionally, the mobile network location identifier is a cell identifier of a mobile network where the terminal is located. The storing the current mobile network location identifier of the terminal in the Wi-Fi access location list specifically is storing the cell identifier of the mobile network where the terminal is located in the Wi-Fi access location list.

Optionally, the terminal may further obtain a Wi-Fi SSID corresponding to a current access point of the terminal. The terminal stores the obtained Wi-Fi SSID in a record that corresponds to the mobile network location identifier in the Wi-Fi access location list.

In certain embodiments, when the mobile terminal accesses a certain Wi-Fi hot spot for the first time, a Wi-Fi function needs to be enabled in an existing manner. For example, the user actively performs setting on the terminal to enable the Wi-Fi function, or the Wi-Fi function of the terminal is enabled by default. The terminal searches for a Wi-Fi network, and after successfully establishing a connection with a Wi-Fi AP, the mobile terminal reads location information of the current mobile network at the same time, which specifically refers to: a Cell ID (a cell identifier) of GSM and WCDMA networks and a system identifier SID and a network identifier NID of a CDMA network. Then, in a Wi-Fi access location list, a new record is added, and the mobile network location identifier and a Wi-Fi SSID are saved. This process may be automatically completed by the terminal, and user intervention is not required. Alternatively, the terminal may provide corresponding prompt information (for example, whether the Wi-Fi information needs to be saved, and connection may be automatically performed subsequently), and enable the user to actively choose whether to save the record. If the user is enabled to choose whether to save the record, the terminal needs to first check whether the Wi-Fi access location list has a corresponding record, and needs to prompt information to the user only for a new record.

A location coverage of the mobile network is usually much larger than a geographical coverage of a certain Wi-Fi AP, and therefore, it is likely that one mobile network location identifier corresponds to multiple Wi-Fi SSIDs.

For example, the Wi-Fi access location list may adopt the following manner:

| | Mobile Network | |
|---|---|---|
| Sequence Number | Location Identifier | Wi-Fi SSID (optional) |
| 1 | Cell ID 1 | SSID 1, SSID 2, SSID 3 |
| 2 | Cell ID 2 | SSID 4, SSID 5 |
| 3 | Cell ID 3 | SSID 6 |
| . . . | . . . | . . . |

Optionally, when at least two access points are found through searching, the storing the obtained Wi-Fi service set identifier corresponding to the access point in a record that corresponds to the mobile network location identifier in the Wi-Fi access location list includes establishing, by the terminal, a connection with a certain access point among the at least two access points, and after the connection succeeds, obtaining, by the terminal, a Wi-Fi service set identifier corresponding to the certain access point, storing the service set identifier in the record that corresponds to the mobile network location identifier in the Wi-Fi access location list, and then starting a connection process of another access point.

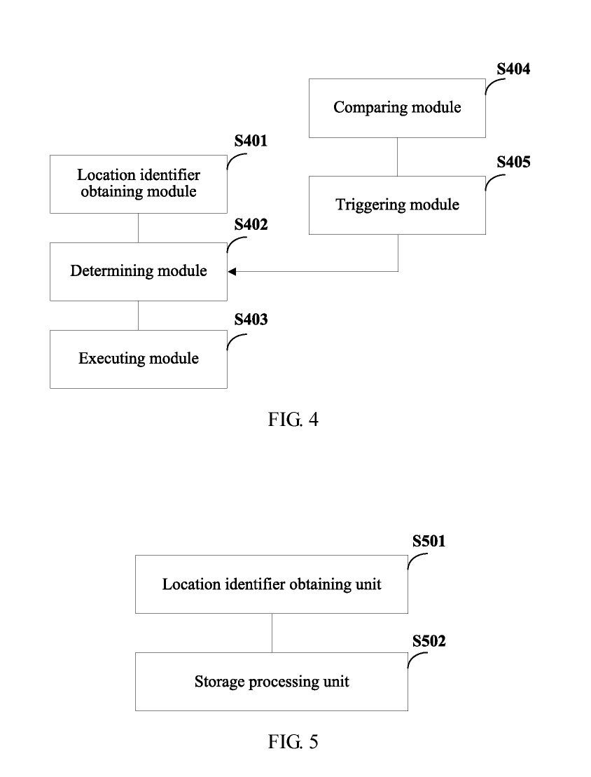

FIG. 4 is a block diagram of one embodiment of a terminal. The embodiment terminal includes a location identifier obtaining module 401, configured to obtain a current mobile network location identifier of the terminal, a determining module 402, configured to determine whether the current mobile network location identifier of the terminal is stored in a Wi-Fi access location list, where the Wi-Fi access location list is used to store a related identifier corresponding to a region that provides Wi-Fi wireless signal access, and an executing module 403, configured to put a Wi-Fi access module in an enabled state and start a Wi-Fi network searching and connection process, when the determining module 402 determines the current mobile network location identifier of the terminal is stored in the Wi-Fi access location list.

Optionally, the terminal may further include a comparing module 404, configured to determine, through comparison, whether the current mobile network location identifier and a previously stored mobile network location identifier are the same, and a triggering module 405, configured to trigger the determining module 402 to determine whether the current mobile network location identifier is stored in the Wi-Fi access location list, when a comparison result of the comparing module 404 is that the two are not the same.

Optionally, the mobile network location identifier specifically is a cell identifier of a mobile network. The location identifier obtaining module 401 is specifically configured to obtain, according to a cell broadcast message delivered by a mobile network, a cell identifier of the mobile network where the terminal is located.

Optionally, the Wi-Fi access location list is further used to store a Wi-Fi service set identifier corresponding to an access point in a region that is indicated by the mobile network location identifier. The executing module 403 is specifically configured to start a Wi-Fi connection process according to a service set identifier of a Wi-Fi network where the terminal is located, when it is determined that the current mobile network location identifier of the terminal is stored in the Wi-Fi access location list.

FIG. 5 is a block diagram of one embodiment of a Wi-Fi access location list creation module. The embodiment Wi-Fi access location list creation module includes a location identifier obtaining unit 501, configured to trigger enabling of a Wi-Fi access module, start a network searching process, and after establishing a connection with an access point that is found through searching, obtain a current mobile network location identifier of a terminal, and a storage processing unit 502, configured to store the mobile network location identifier in a Wi-Fi access location list.

The mobile network location identifier is a cell identifier of a mobile network where the terminal is located. The storage processing unit 502 is specifically configured to store the cell identifier of the mobile network where the terminal is located in the Wi-Fi access location list.

Optionally, the location identifier obtaining unit is further configured to obtain a service set identifier of a Wi-Fi network corresponding to a current access point of the terminal. The storage processing unit 502 is further specifically configured to store the service set identifier of the Wi-Fi network in a record that corresponds to the mobile network location identifier in the Wi-Fi access location list.

Persons of ordinary skill in the art may understand that, all or a part of procedures in the foregoing method embodiments may be accomplished by a computer program instructing relevant hardware. The program may be stored in a computer-readable storage medium. When the program is executed, the procedures of the foregoing method embodiments may be performed. The storage medium may be a magnetic disk, an optical disk, a read-only memory (ROM), or a random access memory (RAM).

Finally, it should be noted that the foregoing embodiments are only provided for describing the technical solutions of the present invention, but are not intended to limit the present invention. It should be understood by persons of ordinary skill in the art that although the present invention has been described in detail with reference to the foregoing embodiments, they may still make modifications to the technical solutions described in the foregoing embodiments, or make equivalent replacements to some technical features in the technical solutions, as long as such modifications or replacements do not cause the essence of corresponding technical solutions to depart from the spirit and scope of the present invention.

What is claimed is:

1. A method for automatically accessing a Wi-Fi network, the method comprising:
obtaining, by a terminal, a current mobile network location identifier of the terminal;
determining, by the terminal, whether the current mobile network location identifier of the terminal is stored in a Wi-Fi access location list, wherein the Wi-Fi access location list is used to store a related identifier corresponding to a region that provides Wi-Fi wireless signal access; and
when the terminal determines that the current mobile network location identifier of the terminal is stored in the Wi-Fi access location list, putting a Wi-Fi access module in an enabled state, and starting a Wi-Fi network searching and connection process.

2. The method according to claim 1, wherein after the obtaining, by the terminal, the current mobile network location identifier of the terminal, the method further comprises:
determining, by the terminal through comparison, whether the current mobile network location identifier and a previously stored mobile network location identifier are the same.

3. The method according to claim 2, wherein the determining, by the terminal, whether the current mobile network location identifier of the terminal is stored in the Wi-Fi access location list comprises:
when a comparison result of the current mobile network location identifier and the previously stored mobile network location identifier is negative, determining, by the terminal, whether the current mobile network location identifier is stored in the Wi-Fi access location list.

4. The method according to claim 2, wherein the mobile network location identifier specifically is a cell identifier of a mobile network.

5. The method according to claim 4, wherein the obtaining, by the terminal, the current mobile network location identifier of the terminal further comprises:
obtaining, by the terminal according to a cell broadcast message delivered by a mobile network, a cell identifier of the mobile network where the terminal is located.

6. The method according to claim 5, wherein the Wi-Fi access location list is further used to store a Wi-Fi service set identifier corresponding to an access point in a region that is indicated by the cell identifier of the mobile network; and
the starting, by the terminal, the Wi-Fi network searching and connection process further comprises: starting, by the terminal, the Wi-Fi network searching and connection process according to the Wi-Fi service set identifier corresponding to the access point in the region where the terminal is located.

7. A Wi-Fi access location list creation method, comprising:
triggering enabling of a Wi-Fi access module, and starting a network searching process;
establishing, by a terminal according to a network searching result, a connection with an access point that is found through searching; and
obtaining, by the terminal, a current mobile network location identifier of the terminal, and storing the mobile network location identifier in a Wi-Fi access location list.

8. The Wi-Fi access location list creation method according to claim 7, wherein the mobile network location identifier is a cell identifier of a mobile network where the terminal is located, and
the storing the current mobile network location identifier of the terminal in the Wi-Fi access location list includes storing the cell identifier of the mobile network where the terminal is located in the Wi-Fi access location list.

9. The Wi-Fi access location list creation method according to claim 8, wherein the terminal further obtains a Wi-Fi service set identifier corresponding to a current access point of the terminal; and
the terminal stores the obtained Wi-Fi service set identifier in a record that corresponds to the mobile network location identifier in the Wi-Fi access location list.

10. The Wi-Fi access location list creation method according to claim 9, wherein when at least two access points are found through searching, the storing the obtained Wi-Fi service set identifier in the record that corresponds to the mobile network location identifier in the Wi-Fi access location list comprises:
establishing, by the terminal, a connection with a certain access point among the at least two access points; and
after the connection succeeds, obtaining, by the terminal, a service set identifier of a Wi-Fi network corresponding to the access point, storing the identifier in the record that corresponds to the mobile network location identifier in the Wi-Fi access location list, and then starting a connection process of another access point.

11. A terminal comprising a central processing unit (CPU), wherein the CPU comprises:
a location identifier obtaining module configured to obtain a current mobile network location identifier of the terminal;
a determining module configured to determine whether the current mobile network location identifier of the terminal is stored in a Wi-Fi access location list, wherein the Wi-Fi access location list is used to store a related identifier corresponding to a region that provides Wi-Fi wireless signal access; and
an executing module configured to put a Wi-Fi access module in an enabled state, and start a Wi-Fi network searching and connection process, when the determining module determines that the current mobile network location identifier of the terminal is stored in the Wi-Fi access location list.

12. The terminal according to claim 11, wherein the CPU further comprises:
a comparing module configured to determine whether the current mobile network location identifier and a previously stored mobile network location identifier are the same through comparison; and
a triggering module configured to trigger the determining module to determine whether the current mobile network location identifier is stored in the Wi-Fi access location list, when a comparison result of the comparing module indicates the two are not the same.

13. The terminal according to claim 12, wherein the mobile network location identifier is a cell identifier of a mobile network; and
the location identifier obtaining module is further configured to obtain, according to a cell broadcast message delivered by a mobile network, a cell identifier of the mobile network where the terminal is located.

14. The terminal according to claim 13, wherein the Wi-Fi access location list is further used to store a Wi-Fi service set identifier corresponding to an access point in a region that is indicated by the cell identifier of the mobile network; and
the executing module is further configured to start a Wi-Fi connection process according to the Wi-Fi service set identifier that corresponds to the access point, when the current mobile network location identifier of the terminal is stored in the Wi-Fi access location list.

15. A Wi-Fi access location list creation module, comprising:
a location identifier obtaining unit configured to trigger enabling of a Wi-Fi access module, start a network searching process, and, after establishing a connection with an access point that is found through searching, obtain a current mobile network location identifier of a terminal; and
a storage processing unit configured to store the mobile network location identifier in a Wi-Fi access location list.

16. The creation module according to claim 15, wherein the mobile network location identifier is a cell identifier of a mobile network where the terminal is located, and
the storage processing unit is further configured to store the cell identifier of the mobile network where the terminal is located in the Wi-Fi access location list.

17. The creation module according to claim 16, wherein the location identifier obtaining unit is further configured to obtain a Wi-Fi service set identifier corresponding to a current access point of the terminal; and
the storage processing unit is further configured to store the Wi-Fi service set identifier in a record that corresponds to the mobile network location identifier in the Wi-Fi access location list.
